(19) United States
(12) Patent Application Publication
(10) Pub. No.: US 2020/0082561 A1
(43) Pub. Date: Mar. 12, 2020

(54) MAPPING OBJECTS DETECTED IN IMAGES TO GEOGRAPHIC POSITIONS

(71) Applicant: Mapbox, Inc., San Francisco, CA (US)

(72) Inventors: Dzianis Karonchyk, Minsk (BY); Andrei Klimovich, Minsk (BY); Dzianis Kanonik, Minsk (BY)

(21) Appl. No.: 16/564,701

(22) Filed: Sep. 9, 2019

Related U.S. Application Data
(60) Provisional application No. 62/729,401, filed on Sep. 10, 2018.
(60) Provisional application No. 62/834,370, filed on Apr. 15, 2019.

(51) Int. Cl. G06T 7/73; G06K 9/00; G06T 11/00; G01C 21/30; G06F 16/587; G06F 16/29

(52) U.S. Cl. CPC G06T 7/73; G06K 9/00791; G06T 11/00; G01C 21/30; G06F 16/587; G01S 19/13; G06T 2207/20084; G06T 2207/30252; G06T 2207/30244; G06T 2207/20076; G06F 16/29

(57) ABSTRACT

A mobile computing device receives an image from a camera physically located within a vehicle. The mobile computing device inputs the image into a machine-learned model that generates a set of object detections. The object detections are filtered for detections of stationary objects and input into an object mapping module. The object mapping module assigns object detections to groups comprised of detections of the same object and uses each group to determine the position of the object relative to the camera. The object mapping module converts the object position relative to the camera position to a geographic position such that the object can (for example) be placed on a map displayed by a map application.

### CROSS REFERENCE TO RELATED APPLICATIONS

This application claims the benefit of Provisional Application No. 62/729,401 (Atty. Docket #33858-41353), filed on Sep. 10, 2018, and of Provisional Application No. 62/834,370 (Atty. Docket #33858-43377), filed on Apr. 15, 2019, both of which are incorporated herein by reference.

### FIELD OF ART

This description relates to image processing and object detection in images, and particularly to mapping stationary objects detected in a plurality of images to geographic positions.

### BACKGROUND

Digital electronic maps are widely used today for navigation, ride sharing, and video games, among other uses. While stand-alone map applications often include many of these functionalities, other applications can make use of electronic maps by calling a map server through an Application Programming Interface (API) on computing devices.

Some map applications process camera images in real time and detect objects present in the images. However, a single object detection in an individual image does not allow for an object to be placed with high precision on the map displayed by the map application. Existing techniques for mapping objects to geographic positions using one or more object detections are imprecise or cannot operate in real time as images are received and objects are detected on a client device. As a result, users of map applications see objects displayed in inaccurate positions on virtual maps or do not have access to object positions when they are most relevant. As a result, there is a need for map applications that can identify with high precision the geographic location of objects detected in processed images in real time.

### SUMMARY

A technique for mapping objects detected in a plurality of images to geographic positions is disclosed herein. In the embodiments discussed below the technique is implemented on a mobile computing device (e.g. a smart phone), although the method can be implemented on any client-side or server-side computing device, or on a combination thereof. The mobile computing device receives a plurality of images from a camera, e.g., a camera physically located within a vehicle. The mobile computing device inputs the images into a vision model loaded into a memory of the mobile computing device. The vision model is configured to generate a set of object detections (that is, data representing the classification and image location of detected objects) for objects appearing in the received images. The mobile computing device filters the set of object detections to comprise only detections of stationary objects (that is, inanimate objects that are not moving). The mobile computing device associates, with each object detection in the set of stationary object detections, camera information including at least the position of the camera when the image in which the object was detected was captured. Camera position information is obtained using the GPS receiver on the mobile computing device. The mobile computing device inputs the set of stationary object detections into an object mapping module. The object mapping module assigns each received stationary object detection to a group of object detections, where an object detection group consists of detections of the same distinct object in the environment. If no group exists for a received stationary object detection, then the object mapping module creates a new group and assigns the stationary object detection to the new group. When an object detection group receives a threshold number of object detections, the object mapping module localizes the position of the distinct object relative to the camera. The object mapping module converts the object position relative to the camera to a geographic position using the camera position information of the mobile computing device.

The geographic object positions output by the object mapping module can be used to display virtual content at geographically accurate locations. For example, the mobile computing device can display a virtual representation of a detected object on a digital map at the actual location where the object is on the Earth. In another example, the mobile computing device can display digital objects relative to the geographic position of the detected object on a digital map or in a live video feed on the mobile computing device.

### BRIEF DESCRIPTION OF THE DRAWINGS

FIG. 1 illustrates an example computer system in which the techniques described may be practiced, according to one embodiment.

FIG. 2 shows an example environment of the context in which a trained vision model may be used, according to one embodiment.

FIG. 3 shows an example of a processed image processed by the vision model in which objects are detected.

FIG. 4A is a flowchart for training the vision model, according to one embodiment.

FIG. 4B is a flowchart for using the trained vision model on live images captured by a mobile computing device, according to one embodiment.

FIG. 5 is a flowchart for computing the geographic position of a detected object using grouped object detections and camera position information, according to one embodiment.

FIG. 6 is a flowchart for positioning object detections on a map displayed by a client map application, according to one embodiment.

FIG. 7A illustrates a linear system-based technique for determining the position of a detected object relative to the camera, according to one embodiment.

FIG. 7B illustrates a ray projection-based technique for determining the position of a detected object relative to the camera, according to one embodiment.

FIG. 7C illustrates a probability distribution-based technique for determining the position of a detected object relative to the camera, according to one embodiment.

FIG. 8A is a flowchart for determining the position of a detected object relative to a vehicle using a system of linear system-based technique, according to one embodiment.

FIG. 8B is a flowchart for determining the position of a detected object relative to a vehicle using a ray projection-based technique, according to one embodiment.

FIG. 8C is a flowchart for determining the position of a detected object relative to a vehicle using a probability distribution-based technique, according to one embodiment.

FIG. 9 illustrates an example computer system upon which embodiments may be implemented.

### DETAILED DESCRIPTION

### I. System Environment & Architecture

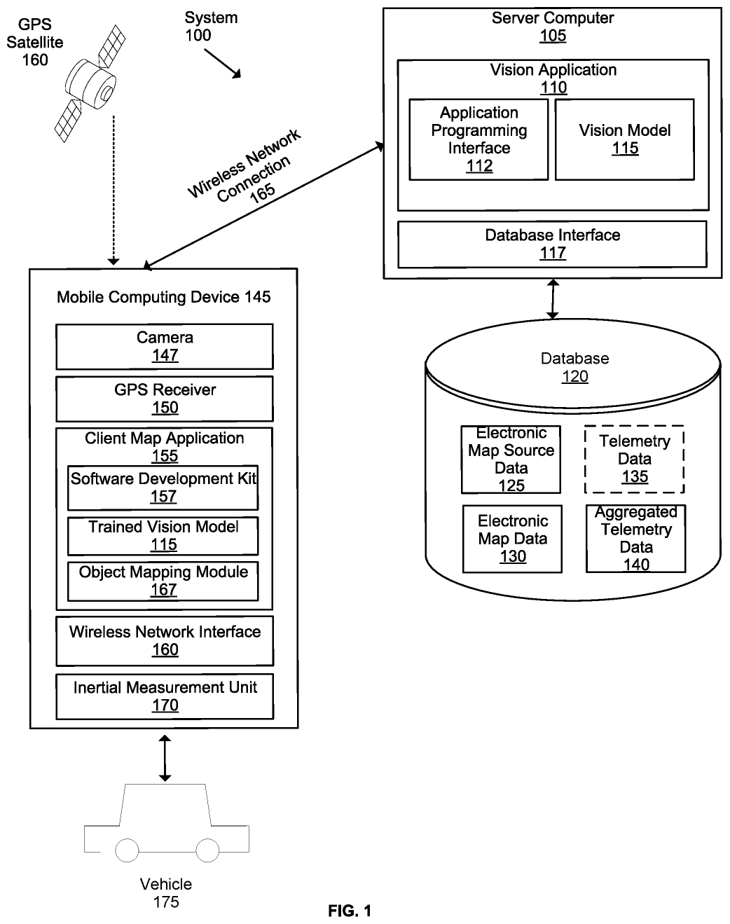

FIG. 1 illustrates an example computer system in which the techniques described may be practiced, according to one embodiment.

A computer system 100 comprises components that are implemented at least partially by hardware at one or more computing devices, such as one or more hardware processors executing stored program instructions stored in one or more memories for performing the functions that are described herein. In other words, all functions described herein are intended to indicate operations that are performed using programming in a special-purpose computer or general-purpose computer, in various embodiments. FIG. 1 illustrates only one of many possible arrangements of components configured to execute the programming described herein. Other arrangements may include fewer or different components, and the division of work between the components may vary depending on the arrangement.

FIG. 1 illustrates a mobile computing device 145 that is coupled via a wireless network connection 165 to a server computer 105, which is coupled to a database 120. A GPS satellite is coupled via a wireless connection to the mobile computing device 145. In one embodiment, the server computer 105 comprises a vision application 110, an application programming interface (API) 112, a trained vision model 115, and a database interface 117. The database 120 comprises electronic map source data 125, electronic map data 130, telemetry data 135, and aggregated telemetry data 140. The mobile computing device 145 comprises a camera 147, a GPS receiver 150, a client map application 155, a wireless network interface 159, and an inertial measurement unit 170. The client map application 155 includes the trained vision model 115, a software development kit (SDK) 157, and an object mapping module 167. The client map application 155 is hosted by the mobile computing device 145, and in one embodiment runs the trained vision model 115 and the object mapping module 167. The object mapping module 167 determines the geographic position of an object in the environment detected in images captured by camera 147 using a group of object detections from one or more images corresponding to the object. The client map application 155 uses the output of the object mapping module 167 in a number of ways, as discussed in the following sections.

Server computer 105 may be any computing device, including but not limited to: servers, racks, workstations, personal computers, general purpose computers, laptops, Internet appliances, wireless devices, wired devices, multi-processor systems, mini-computers, and the like. Although FIG. 1 shows a single element, the server computer 105 broadly represents one or multiple server computers, such as a server cluster, and the server computer may be located in one or more physical locations. Server computer 105 also may represent one or more virtual computing instances that execute using one or more computers in a datacenter such as a virtual server farm.

Server computer 105 is communicatively connected to database 120 and mobile computing device 145 through any kind of computer network using any combination of wired and wireless communication, including, but not limited to: a Local Area Network (LAN), a Wide Area Network (WAN), one or more internetworks such as the public Internet, or a company network. Server computer 105 may host or execute vision application 110, and may include other applications, software, and other executable instructions, such as database interface 117, to facilitate various aspects of embodiments described herein.

Database interface 117 is a programmatic interface such as JDBC or ODBC for communicating with database 120. Database interface 117 may communicate with any number of databases and any type of database, in any format. Database interface 117 may be a piece of custom software created by an entity associated with the vision application 110, or may be created by a third-party entity in part or in whole.

Database 120 is a data storage subsystem consisting of programs and data that is stored on any suitable storage device such as one or more hard disk drives, memories, or any other electronic digital data recording device configured to store data. Although database 120 is depicted as a single device in FIG. 1, database 120 may span multiple devices located in one or more physical locations. For example, database 120 may include one or nodes located at one or more data warehouses. Additionally, in one embodiment, database 120 may be located on the same device or devices as server computer 105. Alternatively, database 120 may be located on a separate device or devices from server computer 105.

Database 120 may be in any format, such as a relational database or a noSQL database. Database 120 is communicatively connected with server computer 105 through any kind of computer network using any combination of wired and wireless communication of the type previously described. Optionally, database 120 may be communicatively connected with other components, either directly or indirectly, such as one or more third party data suppliers. Generally, database 120 stores data related to electronic maps including, but not limited to: electronic map source data 125, electronic map data 130, telemetry data 135, and aggregated telemetry data 140. These datasets may be stored as columnar data in a relational database or as flat files, for example.

Electronic map source data 125 is raw digital map data that is obtained, downloaded or received from a variety of sources. The raw digital map data may include satellite images, digital street data, building data, place data or terrain data. Example sources include National Aeronautics and Space Administration (NASA), United States Geological Survey (USGS), and DigitalGlobe. Electronic map source data 125 may be updated at any suitable interval, and may be stored for any amount of time. Once obtained or received, electronic map source data 125 is used to generate electronic map data 130.

Electronic map data 130 is digital map data that is provided, either directly or indirectly, to client map applications, such as client map application 155, using an API. Electronic map data 130 is based on electronic map source data 125. Specifically, electronic map source data 125 is processed and organized as a plurality of vector tiles which may be subject to style data to impose different display styles. Electronic map data 130 may be updated at any suitable interval, and may include additional information beyond that derived from electronic map source data 125. For example, using aggregated telemetry data 140, discussed below, various additional information may be stored in the vector tiles, such as traffic patterns, turn restrictions, detours, common or popular routes, speed limits, new streets, and any other information related to electronic maps or the use of electronic maps.

Telemetry data 135 is digital data that is obtained or received from mobile computing devices via function calls that are included in a Software Development Kit (SDK) that application developers use to integrate and include electronic maps in applications. As indicated by the dotted lines, telemetry data 135 may be transiently stored, and is processed as discussed below before storage as aggregated telemetry data 140.

The telemetry data may include mobile device location information based on GPS signals. For example, telemetry data 135 may comprise one or more digitally stored events, in which each event comprises a plurality of event attribute values. Telemetry events may include: session start, map load, map pan, map zoom, map tilt or rotate, location report, speed and heading report, or a visit event including dwell time plus location. Telemetry event attributes may include latitude-longitude values for the then-current position of the mobile device, a session identifier, instance identifier, application identifier, device data, connectivity data, view data, and timestamp.

Aggregated telemetry data 140 is telemetry data 135 that has been processed using anonymization, chunking, filtering, or a combination thereof. Anonymization may include removing any data that identifies a specific mobile device or person. Chunking may include segmenting a continuous set of related telemetry data into different segments or chunks representing portions of travel along a route. For example, telemetry data may be collected during a drive from John's house to John's office. Chunking may break that continuous set of telemetry data into multiple chunks so that, rather than consisting of one continuous trace, John's trip may be stored as a trip from John's house to point A, a separate trip from point A to point B, and another separate trip from point B to John's office. Chunking may also remove or obscure start points, end points, or otherwise break telemetry data into any size. Filtering may remove inconsistent or irregular data, delete traces or trips that lack sufficient data points, or exclude any type or portion of data for any reason. Once processed, aggregated telemetry data 140 is stored in association with one or more tiles related to electronic map data 130. Aggregated telemetry data 140 may be stored for any amount of time, such as a day, a week, or more. Aggregated telemetry data 140 may be further processed or used by various applications or functions as needed.

Mobile computing device 145 is any mobile computing device, such as a laptop computer, hand-held computer, wearable computer, cellular or mobile phone, portable digital assistant (PDA), or tablet computer. Although a single mobile computing device is depicted in FIG. 1, any number of mobile computing devices may be present. Each mobile computing device 145 is communicatively connected to server computer 105 through wireless network connection 165 which comprises any combination of a LAN, a WAN, one or more internetworks such as the public Internet, a cellular network, or a company network. One skilled in the art will readily recognize from the following discussion that alternative embodiments of a mobile computing device 145 (e.g., a non-mobile client device) are possible. For example, the system may use a computing device that is embedded on the vehicle 175.

Mobile computing device 145 is communicatively coupled to GPS satellite 160 using GPS receiver 150. GPS receiver 150 is a receiver used by mobile computing device 145 to receive signals from GPS satellite 160, which broadly represents three or more satellites from which the mobile computing device may receive signals for resolution into a latitude-longitude position via triangulation calculations.

Mobile computing device 145 also includes wireless network interface 159 which is used by the mobile computing device to communicate wirelessly with other devices. In particular, wireless network interface 159 is used to establish wireless network connection 165 to server computer 105. Wireless network interface 159 may use WiFi, WiMAX, Bluetooth, ZigBee, cellular standards or others.

Mobile computing device 145 also includes other hardware elements, such as one or more input devices, memory, processors, and the like, which are not depicted in FIG. 1. Mobile computing device 145 also includes applications, software, and other executable instructions to facilitate various aspects of embodiments described herein. These applications, software, and other executable instructions may be installed by a user, owner, manufacturer, or other entity related to mobile computing device.

Mobile computing device 145 also includes a camera device 147. The camera 147 may be external, but connected, to the mobile computing device 145. Alternatively, the camera 147 may be an integrated component of the mobile computing device 145. Camera 147 functionality may include the capturing of infrared and visible light.

Mobile computing device 145 may include a client map application 155 which is software that displays, uses, supports, or otherwise provides electronic mapping functionality as part of the application or software. Client map application 155 may be any type of application, such as a taxi service, a video game, a chat client, a food delivery application, etc. In one embodiment, client map application 155 obtains electronic mapping functions through SDK 157, which may implement functional calls, callbacks, methods or other programmatic means for contacting the server computer to obtain digital map tiles, layer data, or other data that can form the basis of visually rendering a map as part of the application. In general, SDK 157 is a software development kit that allows developers to implement electronic mapping without having to design all of the components from scratch. For example, SDK 157 may be downloaded from the Internet by developers, and subsequently incorporated into an application which is later used by individual users.

The trained vision model 115 receives images from the camera 147. In one embodiment, the client map application 155 may also receive processed images from the trained vision model 115. In one embodiment, the trained vision model 115 is configured to output sets of object detections.

The object mapping module 167 receives object detections from the trained vision model 115. In one embodiment, the object mapping module 167 also receives a position of the camera 147 included with each object detection, where the camera position corresponds to the time the image containing the object detection was captured by the camera. In one embodiment, the object mapping module 167 is configured to output the geographic position of each detected object. As used herein, the term “geographic position” refers to a location on the Earth's surface. For example, a geographic position may be represented using longitude-latitude values.

In server computer 105, the vision application 110 provides the API 112 that may be accessed, for example, by client map application 155 using SDK 157 to provide electronic mapping to client map application 155. Specifically, the vision application 110 comprises program instructions that are programmed or configured to perform a variety of backend functions needed for electronic mapping including, but not limited to: sending electronic map data to mobile computing devices, receiving telemetry data 135 from mobile computing devices, processing telemetry data to generate aggregated telemetry data 140, receiving electronic map source data 125 from data providers, processing electronic map source data 125 to generate electronic map data 130, and any other aspects of embodiments described herein.

### II. Operating Environment for Use of the Object Mapping Module

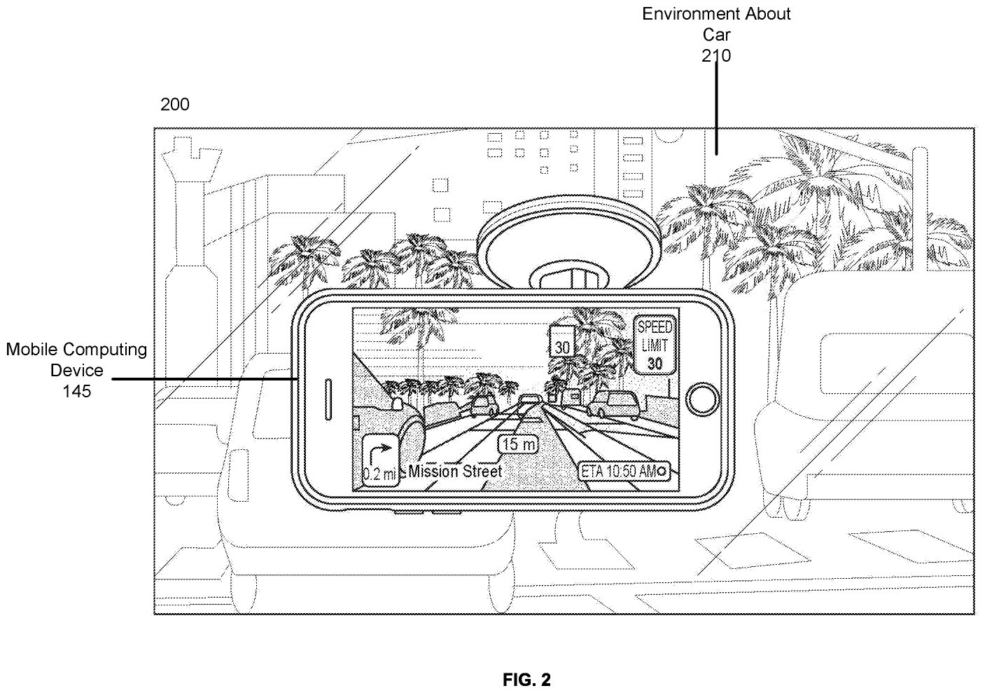

As shown in FIG. 1, the object mapping module 167 is hosted by a mobile computing device 145 (e.g., one located within a vehicle 175). FIG. 2 illustrates an example environment in which an object mapping module may be used, according to one embodiment. Generally, the mobile computing device 145 will be mounted within the vehicle, for example on the vehicle's windshield or on its dashboard. The mobile computing device's camera's 147 field of view would be of the environment about the vehicle 210, where images (frames) captured by the camera are input into the trained vision model 115. As used herein, the environment refers to the real-world context any component of the system inhabits at the time of operation. For each input image, the trained vision model 115 outputs a set of object detections. The client map application 155 filters the set of object detections output by the trained vision model 115 to comprise detections of stationary objects, where stationary objects are labeled using the object detection classification labels. For example, for one particular application oriented toward mapping traffic and road related objects to geographic positions road signs and traffic lights could remain in the set of object detections, while vehicles and pedestrians could be removed. In one embodiment, after an image is processed and a corresponding set of stationary object detections is obtained from the output of the trained vision model 115, the camera 175 position at the time the image was captured is added to each object detection by the client map application 155. In the same or different embodiment, the camera 175 orientation at the time the image was captured is added to each object detection by the client map application 155. The position and orientation of the camera 175 are derived from the geolocation of the mobile computing device 145 provided as GPS coordinates by the GPS receiver 150. In one embodiment, the camera position and orientation are derived using a process taught in co-pending U.S. patent application Ser. No. ______ (Atty Docket #33858-43814), entitled “Calibration for Vision in Navigation Systems”, filed on ______. In various embodiments, the camera 147 position, the mobile computing device 145 position, and the vehicle 175 position are represented as the same position. The disclosure below employs the term “camera position” to refer to the position of a camera that is a component of a mobile computing device located within a vehicle.

The object mapping module 167 receives object detections including respective camera 147 positions as input. For each distinct object in the environment about the vehicle 175, the object mapping module outputs a geographic position of the object. In one embodiment, after the client map application 155 receives the geographic position of a distinct object in the environment it positions the object on a map displayed on the mobile computing device screen by the client map application. In the same or different embodiment, after processing by the client map application 155, the live camera view or some processed view thereof is displayed on the mobile computing device screen for the user's view. In the same or a different embodiment, computer code associated with a software application loaded on the mobile computing device 145 (e.g., the client map application 155) alerts the user regarding detected objects mapped to geographic positions and positioned on a map in the client map application, examples of which include but are not limited to road signs, cross-walks, and traffic lights. In the same or a different embodiment, the output of the object mapping module 167 is used to provide new or updated map information to the server 105, including locations of road signs, cross-walks, and traffic lights.

Although in the embodiments described herein the operating environment for the object mapping module is on a mobile computing device, one skilled in the art will readily recognize from the following discussion that alternative embodiments are possible. For example, object mapping module may operate on server 105 where object detections have been aggregated from one or more mobile computing devices.

### III. Trained Vision Model Output

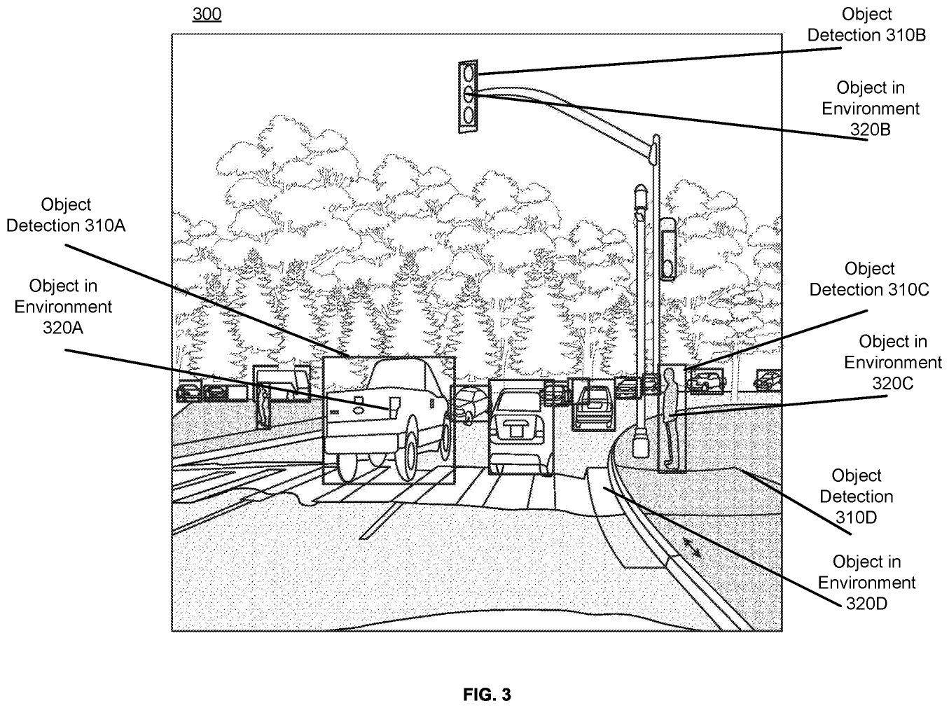

FIG. 3 shows an example of an image processed by the vision model in which objects are detected and the image's pixels are segmented. The trained vision model 115 includes a neural network that processes each frame of the live camera view of the mobile computing device 145 and then generates a set of object detections 310. Object detections 310 are representations of real world objects 320 detected in the environment relative to a particular image. Object detections may be represented by a classification (e.g. the type of object in the environment 320) and the size and location (e.g., origin) of a bounding box within the image in which the object was detected. Object detections 310 include discrete shapes around which bounding boxes can be placed in the image. Example classifications in some embodiments include pedestrians, bike riders, vehicles, road signs, traffic lights, and so on, as depicted in FIG. 3. In some embodiments, object detections include more than one level of classification, such as a first level indicating a general type (e.g., pedestrian, sign, vehicle), and a more specific type of the general type (e.g. a stop sign, or a speed limit sign). For example, object detection 310A could have general type “vehicle” and specific type “truck.”

### IV. Training and Inference of the Vision Model

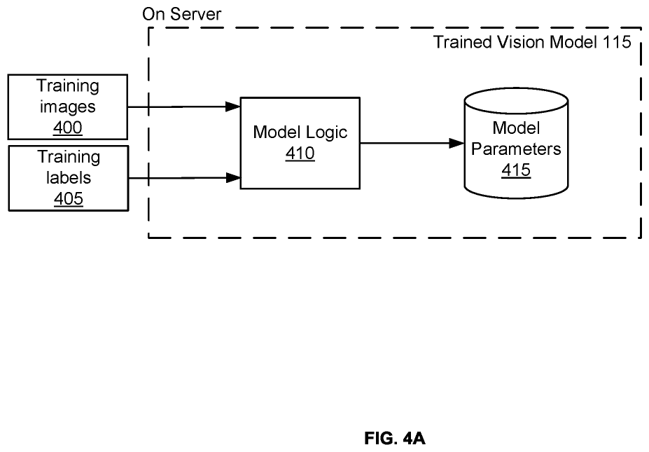

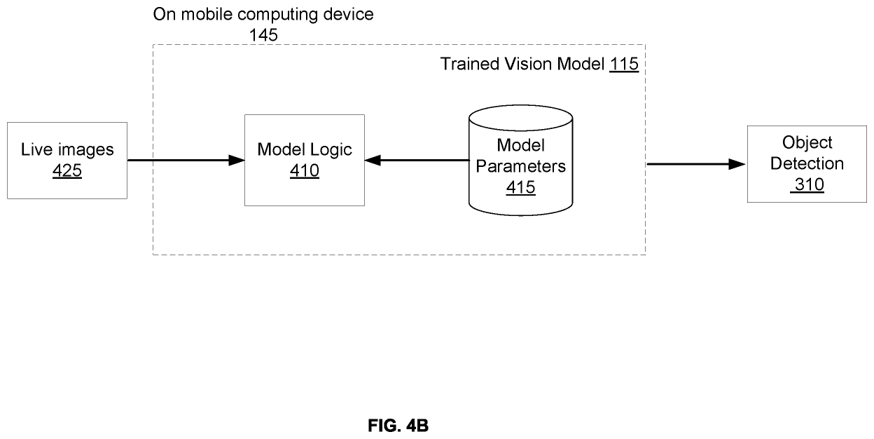

FIG. 4A is a flowchart for training the trained vision model 115, according to one embodiment. On the server 105, a set of training images 400 and an associated set of training labels 405 are input into the vision model 115. In some embodiments, the training images and labels are specific to traffic-related contexts and include objects such as road signs, traffic lights, vehicles, and pedestrians. In the same or different embodiments, the training images are labeled by a human. The training images 400 and labels 405 are used in conjunction with model logic 410 to determine a set of model parameters 415 that, once determined, are stored. The model logic 410 includes at least a function relating the model parameters 415 and an image input into the model to a set of outputs. The model logic 410 generally also includes a loss function or other model training information that determines how the model parameters 415 are to be trained using the set of training images and labels. The exact function, loss function, and outputs of the trained vision model 115 may vary by implementation.

FIG. 4B is a flowchart for using the trained vision model on live images captured by a mobile computing device 145, according to one embodiment. As discussed above, a common use case for the trained vision model 115 assumes storage and loading of the trained vision model 115 in memory of the mobile computing device 145. On the mobile computing device 145, live images 425 from the camera 147 are input into the trained vision model 115, more specifically model logic 410. The model logic 410 of the trained vision model 115 accesses the stored model parameters 415. The model logic 410 uses the model parameters 415 and live camera images 425 to determine model outputs, e.g., object detections 310, examples of which are illustrated in FIG. 3.

### V. Example Vision Model Architecture

Although there are a number of model architectures that may function adequately for performing detection and image segmentation tasks on a set of images, generally these model architectures are designed for use with traditional desktop or cloud computing resources, both in terms of processor computation ability, and also in that they have wired connection to electrical power. Mobile computing devices, by contrast, are limited in both regards. As such, model architectures that require a great deal of electrical power or compute ability are infeasible for use with mobile computing devices.

Particularly in this context, the goal of the trained vision model 115 is to run continuously on the mobile computing device 145 as a driver operates a vehicle traveling from one destination to another, while consuming as little compute ability and power as possible, while also achieving desired object detection and segmentation on the images processed by the trained vision model 115. The methods taught in pending U.S. patent application Ser. No. 16/354,108, entitled “Low Power Consumption Deep Neural Network for Simultaneous Object Detection and Semantic Segmentation in Images on a Mobile Computing Device,” filed on Mar. 14, 2019, disclose an embodiment of a trained vision model working in this desired context.

### VI. Object Mapping with Grouped Object Detections

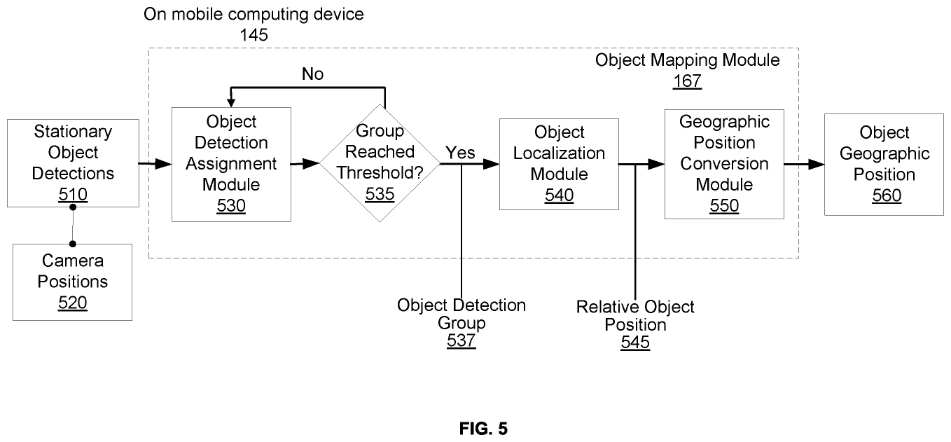

FIG. 5 is a flowchart for determining detected object geographic positions with the object mapping module 167, according to one embodiment. The object mapping module 167 receives stationary object detections 510, each having an associated camera 147 position 520, from the mobile computing device 145. The object detection assignment module 530 assigns each received object detection to a group of object detections corresponding to the same distinct object in the environment about the vehicle 175. If no group exists for a received object detection, then the object detection assignment module 530 creates a new group containing only the received object detection. In one embodiment, object detections are assigned to groups based on classification label, bounding box location, bounding box size, or other object detection features. In the same or different embodiment, object detection assignment is performed using an algorithm solving the “assignment” problem, which comprises a class of algorithms that find a matching in a weighted bipartite graph where the sum of edge weights is as large as possible. For example, the object detection assignment module may use the Hungarian algorithm.

If an object detection group 537 receives 535 a threshold number of object detections required by the object mapping module 167, the object detection assignment module 530 inputs the object detection group 537 into the object localization module 540. The object localization module 540 processes the plurality of object detections in a group corresponding to a distinct object to compute a position of the distinct object relative to the camera 147. The relative object position 545 describes the real-world position of the distinct object in relation to the camera 147 at various real-world positions. In one embodiment, the object detection includes camera parameters which describe attributes of camera 147 such as the type of lens and the lens focal distance. In the same or different embodiment, the object localization 540 module has access to known sizes for specific object classification labels. In some embodiments, these known sizes are provided by a size range. For example, a stop sign classification may have a corresponding known size of 1.8-2 m height, 0.5-0.7 m width, and 0.2-0.3 m length. Several embodiments of the object localization module 540 are discussed in section VII, below.

The geographic position conversion module 550 receives each relative object position 545 from the object localization module 540 as input and converts each relative object position 545 to a geographic position 560. In one embodiment, the geographic conversion module 550 uses a known geographic camera position derived from the geolocation of the mobile computing device 145 to perform the conversion, e.g., by the coordinate components of the relative object position to those of the geographic camera position.

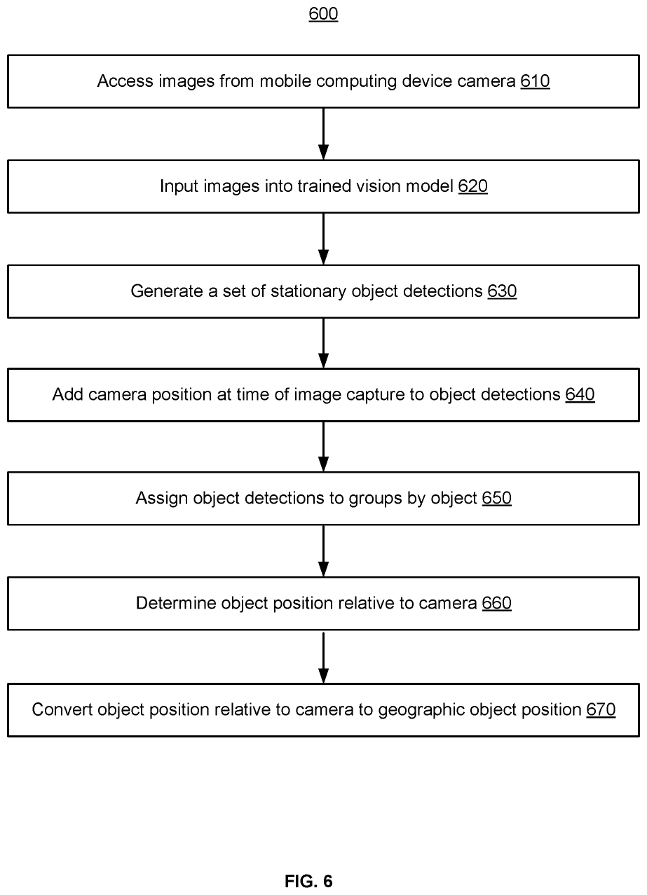

FIG. 6 is a flowchart 600 showing the sequence of events that the client map application 155 follows to determine the geographic position of a detected object in the environment 320. The client map application 155 accesses 610 live images 425 taken from the camera of the mobile computing device 145, e.g. a phone in one embodiment. The client map application 155 inputs 620 the live images 425 into the trained vision model 115. The trained vision model 115 generates 630 a set of object detections, which is filtered by the client map application 155 to comprise detections of stationary objects. The client map application 155 adds 640 to each object detection the camera position corresponding to the time the image containing the object detection was captured by the camera 147. The object mapping module 167 receives the object detections from the client map application 155 and assigns 650 the object detections to groups organized by distinct detected object in the environment 320. The object mapping module 167 determines 660 the position of each detected object in the environment 320 relative to the camera 147 based on the group of object detections corresponding to the object. The object mapping module 167 converts 670 the position of the object in the environment 320 relative to the camera 147 to a geographic position based on the geographic camera 147 position derived from the geolocation of the mobile computing device 145. In one embodiment, the mobile computing device 145 may display the detected object in the environment 320 through the client map application 155, such as by positioning a virtual representation of the object on a digital map displayed by client map application 155.

### VII. Example Object Localization Techniques

Object localization using grouped object detections relies on known estimations of positions, orientations, and sizes of objects in the real world. In various embodiments, these estimated values include a camera position, a camera orientation, and an object size associated with an object classification label. The accuracy of the object positions relative to the camera 147 output by the object localization module 540 depends on the accuracy of these estimated values. As such, there are a number of possible object localization techniques that vary in which known estimated values are used and in the accuracy of the output object position. In particular, alternative techniques employed by different embodiments of the object localization module 540 are now discussed, including (A) a system of linear equations for pixels, (B) ray intersection, and (C) Gaussian fusion.

VII.A. Solving System of Linear Equations for Pixels

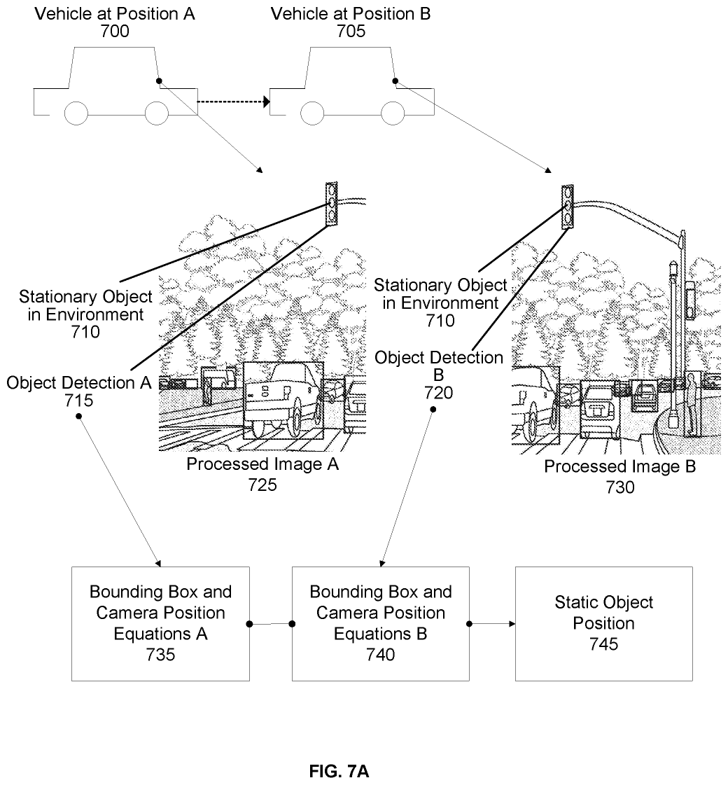

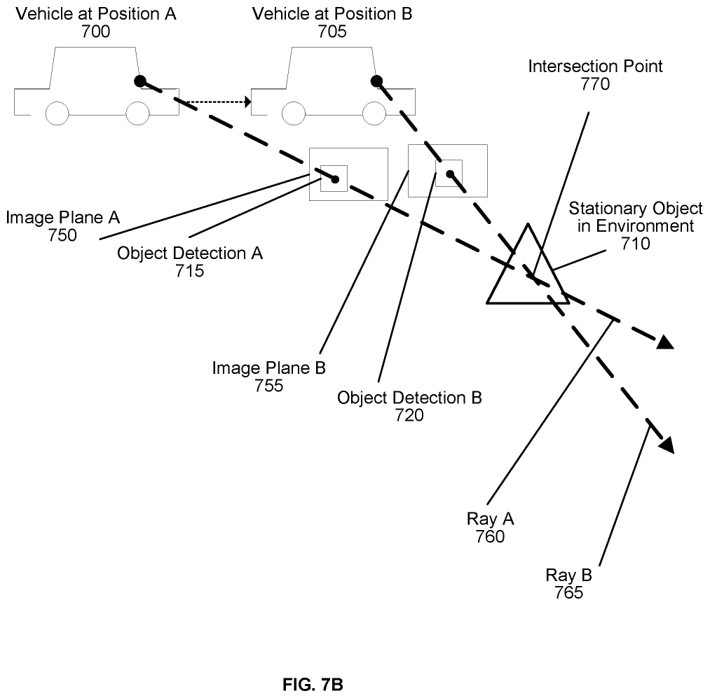

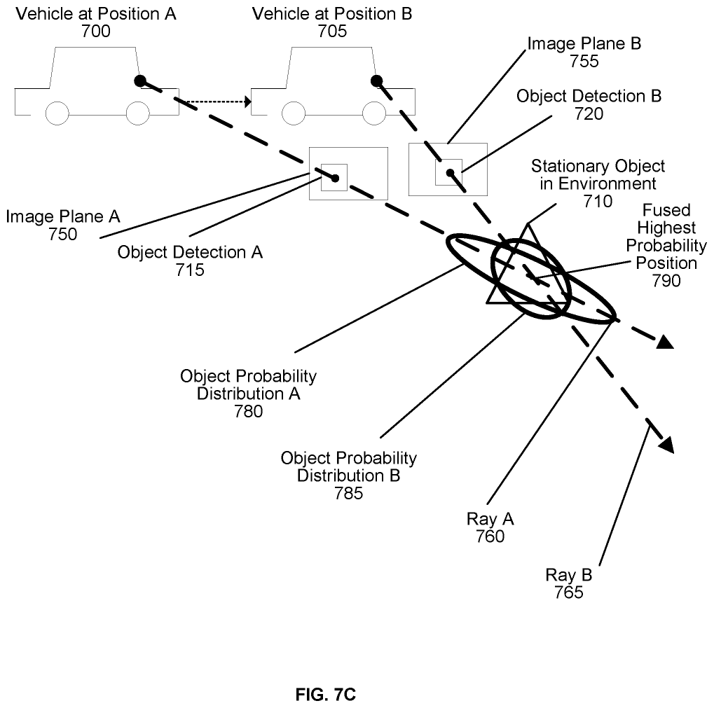

FIG. 7A illustrates an example context for using a system of linear equations to determine the position of a detected object relative to the camera 147. As discussed above, an object detection includes a bounding box indicating an area in an image where an object was detected and a camera position at the time the image was captured. In one embodiment, the bounding box is specified in pixel coordinates by its size and location (e.g., origin) within each image. In the same or different embodiment, the camera position may be specified as a 3-dimensional position in a coordinate frame derived from the geolocation of the mobile computing device 145. An object detection can be used to formulate a series of equations in terms of the known camera position, the known bounding box coordinates, and an unknown object position in the same coordinate frame as the camera. In an object detection group output by object detection assignment module 530, the unknown object position is a constant across each object detection in the group. The equations formulated for each object detection in the object detection group form a system of linear equations. When a threshold number of object detections are assigned to the object detection group to produce more equations than the unknown object position values, the system is solvable for the object position. In the same or different embodiment, each object detection provides four equations, where the equations are given by the coordinate values along both image axes from two positions on the bounding box perimeter. In the same or different embodiment, the system is solvable for the object width and height. In the same or different embodiment, the linear system is solved using linear-least squares approximation.

In FIG. 7A the object localization module 540 receives a group of object detections from the object detection assignment module 530 containing two object detections: object detection A 715 and object detection B 720. Object detection A 715 is a detection of a stationary object in the environment 710 captured by the camera 147 on vehicle 175 when the vehicle is at position A 700. Similarly, object detection B 720 is a detection of the same stationary object in the environment 710 captured by the camera 147 on vehicle 175 at position B 705. Both object detection A 715 and object detection B 720 include a respective bounding box and a camera position, which are used to formulate equations A 735 and equations B 740, respectively. Bounding box and camera position equations A 735 and B 740 are then used to solve for stationary object position 745.

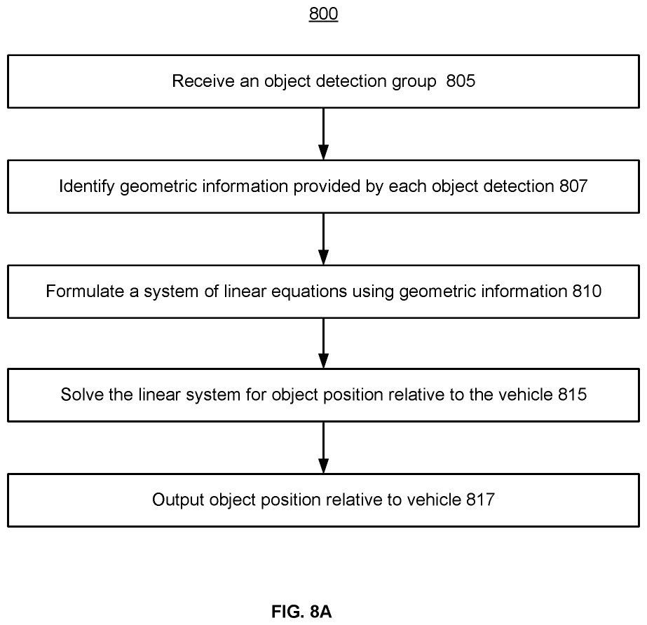

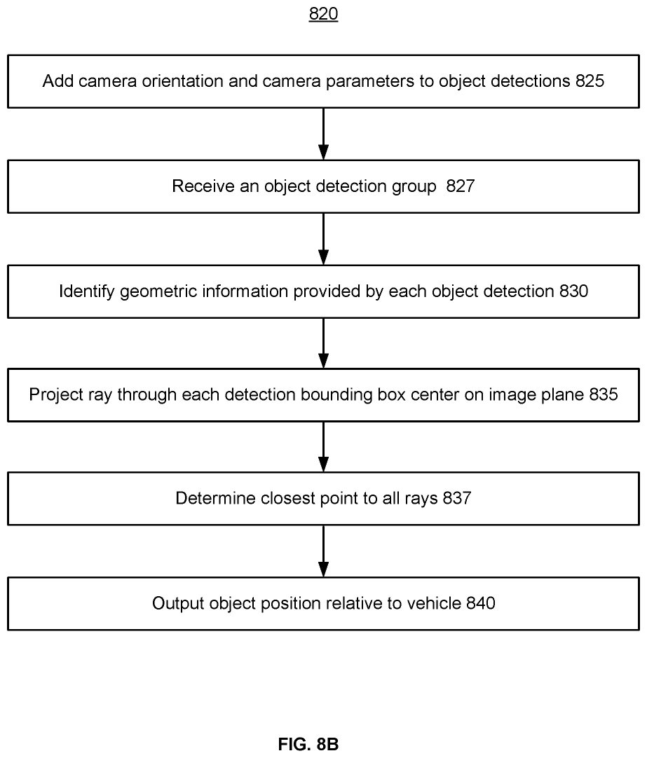

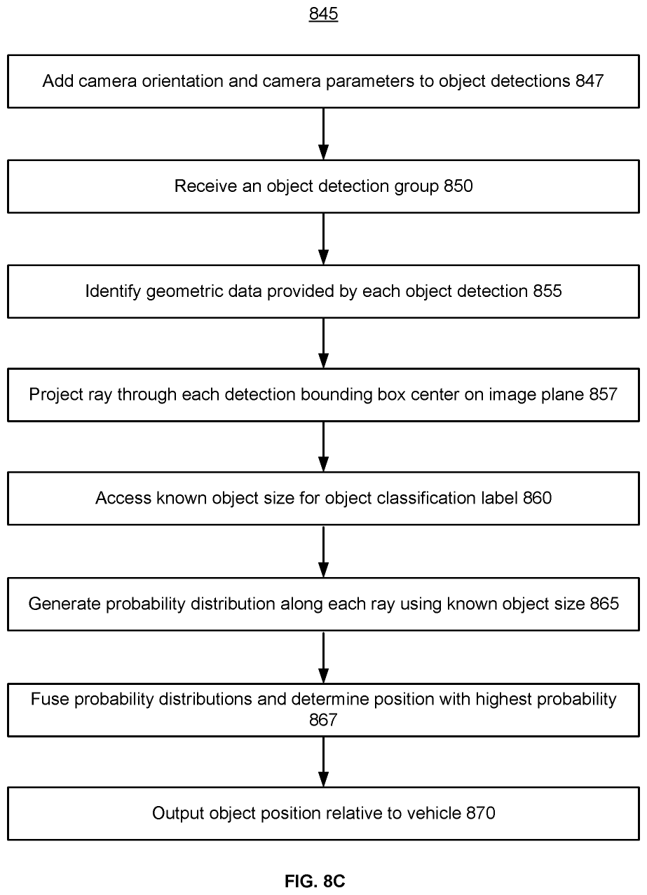

FIG. 8A is a flowchart 800 showing the sequence of actions that the object localization module 540 takes to determine the position of a detected object relative to a camera using a system of linear equations, according to one embodiment. Object localization module 540 receives 805 an object detection group from the object detection assignment module 530 comprised of a threshold number of object detections. Object localization module 540 identifies 807 geometric information provided by each object detection, where geometric information includes a bounding box and a camera position. Object localization module 540 formulates 810 a system of linear equations, where the equations for each object detection are in terms of the geometric information contained in the object detection and a constant object position relative to the camera. Object localization module 540 solves 815 the linear system for the unknown object position relative to the camera and outputs 817 the object position to the geographic position conversion module 550.

VII.B. Intersecting Ray Projections

FIG. 7B illustrates an example context for using ray projections to determine the position of a detected object relative to the camera 147. In some embodiments the object localization module 540 has access to the camera orientation and camera parameters of the camera 147. As discussed above, camera parameters are attributes of camera 147, including the type of lens and the lens focal length. The camera parameters can be used to derive the focal point, which is the position where light rays passing through the camera lens intersect. In one embodiment, the client map application 145 adds, to each object detection output by the trained vision model 115, the camera orientation at the time the image corresponding to the object detection was captured. In the same or different embodiment, the camera position and orientation are specified by a transformation matrix and a rotation matrix in a coordinate frame derived from the geolocation of the mobile computing device 145. For each object detection, the camera 147 position and orientation are used to project a ray in a 3-dimensional coordinate frame from the camera focal point through the bounding box center on the image plane, where the image plane is perpendicular to the lens and at focal length distance from the lens. The ray projection extends from the image plane through the position of the stationary object in the environment captured in the image relative to the camera. In one embodiment, the lens focal point and lens focal length are specified in the same 3-dimensional coordinate frame as the camera position included with an object detection. In an object detection group output by object detection assignment module 530, the nearest point to the ray projections from each object detection (i.e. the intersection) provides the position of the stationary object in the environment 710. In one embodiment, the nearest point to the rays is found using linear-least squares approximation.

In FIG. 7B the object localization module 540 receives object detection A 715 and object detection B 720 as in FIG. 7A. Both object detection A 715 and object detection B 720 contain a respective bounding box, camera position, and camera orientation. Ray A 760 is projected from the focal point of camera 147 on the vehicle at position A 700 through the center of the bounding box from object detection A on image plane A. Similarly, ray B 765 is projected from the focal point of camera 147 on the vehicle at position B 705 through the center of the bounding box from object detection B on image plane B. The closest point to Ray A 760 and Ray B 765 is intersection point 770, which approximates the position of stationary object in the environment 710 relative to the camera 147. Although in FIG. 7B the nearest point to ray A 760 and ray B 765 is an intersection point, in many real-world cases there may not be a single intersection point for all rays due to factors such as estimation errors.

FIG. 8B is a flowchart 820 showing the sequence of actions that the object localization module 540 takes to determine the position of a detected object relative to the camera 147 using ray projections according to one embodiment. Client map application 145 adds 825 corresponding camera position, orientation, and camera parameters to each object detection output by the trained vision model 115. Object localization module 540 receives 827 an object detection group from the object detection assignment module 530 comprised of a threshold number of object detections. Object localization module 540 identifies 830 geometric information provided by each object detection, where geometric information includes a bounding box, a camera position, a camera orientation, and camera parameters. For each object detection in the object detection group, the object localization module 540 projects a ray 835 from the camera focal point through the bounding box center on the image plane, based on the geometric information of the object detection. Object localization module 540 determines 837 the closest point to all the rays, which it interprets as the object position relative to the camera. Object localization module 540 outputs 840 the object position relative to the camera to the geographic position conversion module 550.

VII.C. Fusing Probability Distributions

FIG. 7C illustrates an example context for fusing probability distributions to determine the position of a detected object relative to the camera 147. In some scenarios, the ray projection technique discussed in section VII.B. may not provide an accurate object position relative to the camera because rays may intersect in the wrong place or not intersect at all. To address this, in the same or different embodiments as discussed in section VII.B the object localization module 540 has additional access to an object size associated with an object classification label. In one embodiment, this object size specifies an object size range with a minimum and maximum size. As above, each object detection in an object detection group is used to project a ray in 3-dimensional space, where each object detection corresponds to the same stationary object in the environment. Along each ray a probability distribution is determined using the object size corresponding to the classification label of the object in the environment. Each probability distribution corresponds to a 2-dimensional region centered at a position along the ray in the plane parallel to the ray. For each position in the region the probability distribution includes a value indicating a probability of the object being at that position. The probability distributions along each ray are fused to obtain one probability distribution, where the position with the highest probability indicates the object position relative to the camera 147.

In one embodiment, the location and size of the probability distribution along a given ray is determined based on the pixel coordinates of the bounding box and the known object size. In the same or different embodiment, the position and boundary of the probability distribution in the plane parallel to the ray are based on the position and orientation of the camera 147. In the same or different embodiment, the probability distribution is represented as a multivariate normal distribution (i.e. a gaussian distribution) over two variables. For example, the two variables can be coordinates on the 2-dimensional plane parallel to the ray which are relative to a specific point on the ray where the distribution is centered. In the same or different embodiment, the probability distributions are fused by multiplying each distribution together and normalizing the resulting distribution.

In FIG. 7C the object localization module 540 receives object detection A 715 and object detection B 720 as in FIG. 7A. Geometric information from object detection A 715 and object detection B 720 are used to project ray A 760 and ray B 765 respectively. Using geometric information from object detection A 715 and a provided size associated with the classification label of stationary object in the environment 710, object probability distribution A 780 is generated in a region along ray A 760. Similarly, using geometric information from object detection B 720 and a provided size associated with the classification label of stationary object in the environment 710, object probability distribution B 785 is generated in a region along ray B 765. Object probability distribution A 780 and object probability distribution B 785 are fused, where the highest probability in the fused distribution is at position 790 which approximates the position of stationary object in the environment 710. Note that the fused distribution is not explicitly shown in FIG. 7C.

FIG. 8C is a flowchart 845 showing the sequence of actions that the object localization module 540 takes to determine the position of a detected object relative to the camera 147 using probability distributions according to one embodiment. Client map application 145 adds 847 a corresponding camera position, camera orientation, and camera parameters to each object detection output by the trained vision model 115. Object localization module 540 receives 850 an object detection group from the object detection assignment module 530 comprised of a threshold number of object detections. Object localization module 540 identifies 855 geometric information provided by each object detection, where geometric information includes a bounding box, a camera position, a camera orientation, and camera parameters. For each object detection in the object detection group, the object localization module 540 projects 857 a ray from the camera focal point through the bounding box center on the image plane based on the geometric information of the object detection. Object localization module 540 accesses 860 a known object size associated with the object classification label of the object corresponding to the object detection group. Using the known object size, the object localization module 540 generates 865 a probability distribution along each ray. Object localization module 540 fuses 867 each probability distribution into a single probability distribution and determines the position with the highest probability, which it interprets as the object position relative to the camera. Object localization module 540 outputs 870 the object position relative to the camera to the geographic position conversion module 550.

### VIII. Example Use Cases for Object Mapping

The detected object geographic positions may be used in a number of contexts.

VIII.A. Adding Objects to Map

Each detected object geographic position identifies the real-world location of an object on the Earth's surface. In some embodiments, the client map application 155 uses the geographic position of a detected object and relevant information from corresponding object detections to display a representation of the object on a digital map of the Earth's surface. The client map application 155 can represent the object on a digital map in any format applicable to the functions of the particular map application. For example, if the object mapping module 167 outputs the geographic position of a speed-limit sign, the client map application 155 could display the image of a speed-limit sign with a corresponding speed on the digital map at a map position corresponding to the geographic position.

In some embodiments, the client map application 155 uses the geographic position of a detected object and relevant information from corresponding object detections to display virtual objects in a live video feed displayed by the mobile computing device 145. For example, a client map application 155 may display a virtual stop-sign on the live video feed of mobile computing device 145 to highlight the real-world object to a user, including adding visual emphasis to the virtual stop-sign such as a colored highlight around its outline or on its surface.

VIII.B. Updating Server Map Information

Object geographic positions can be sent to the map server by the mobile computing device 145. Object geographic positions previously added to the map server may be incorrect due to inaccurate camera position or orientation information, too few object detections considered, object detections incorrectly assigned to an object detection group, inaccurate geolocation of the mobile computing device due to phone movement, or the like. To address this, geographic positions of road-related objects such as road signs can be added/updated/deleted on the map server. The object mapping module 167 outputs a set of geographic object positions obtained from object detections provided by the trained vision model 115. The mobile computing device 145 sends detected object information including object geographic positions to the server computer 105, and the server computer 105 receives 745 data describing the detected objects from the mobile computing device 145. The server computer 105 updates 755 the stored map with the detected object geographic positions output by the object mapping module 167.

In one embodiment, the set of live images 425 includes multiple object detections of an object relevant to driving decisions. The trained vision model 115 classifies the object in the images in which it appears. The object mapping module 167 determines a geographic position of the object. The server computer 105 checks the existing map repository for an object of the same type as the classified object near the determined geographic position. If there are discrepancies between the geographic position of the client map application's object and that in the existing map repository, the server computer 105 adjusts the geographic position in the existing map repository to reflect the geographic position of the client device and updates stored database of map information in real time to reflect the geographic position of the client map application's object.

VIII.C. Real Time Object Notifications

In response to a number of rules stored in the memory of the mobile computing device 145, the client map application 155 may notify users about the location of mapped objects either by visual notification or audio alert via the screen or speaker of the mobile computing device 145, respectively. Notifications may be directed at aiding user navigation, encouraging safe driving habits if operating from a vehicle, or alerting users to objects in the environment that may be relevant. For example, a user may be driving a vehicle approaching a geographically positioned stop-sign at a speed indicating the user may not come to a complete stop. In this case, the client map application 155 may alert the user of the stop sign's position within time for the user to safely bring the vehicle to a stop. Rules triggering user notifications may depend on data, such as GPS location or type of road sign, collected from the mobile computing device 145, on which the client map application 155 is running.

In one embodiment, the client map application 155 or object mapping module 167 determines that one or more of the objects mapped to geographic positions by the object mapping module 167 are hazardous. The client map application 155 may automatically warn the user when their vehicle is within a detected distance from the hazard. For example, the client map application 155 may detection and position a stationary object in the lane in which a user is driving a vehicle. In this case, the client map application may alert the user to the stationary object so that the user can change lanes or otherwise avoid the object.

In another embodiment, users of the client map application 155 may set the rules that result in notifications. For example, a user may choose to be notified when the object mapping module 167 determines the geographic position of an object identified as a stop sign ahead of the vehicle.

### IX. Additional Considerations

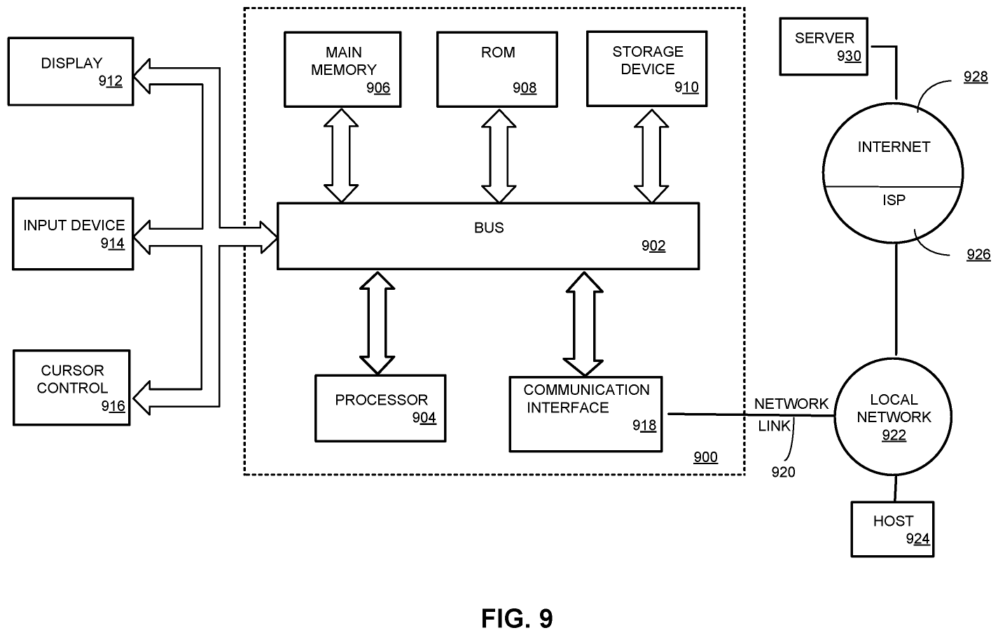

FIG. 9 is a block diagram that illustrates a computer system 900 upon which an embodiment of the invention may be implemented. Computer system 900 includes a bus 902 or other communication mechanism for communicating information, and a hardware processor 904 coupled with bus 902 for processing information. Hardware processor 904 may be, for example, a general purpose microprocessor.

Example computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a LCD screen, LED screen, or touch screen, for displaying information to a computer user. An input device 914, which may include alphanumeric and other keys, buttons, a mouse, a touchscreen, or other input elements is coupled to bus 902 for communicating information and command selections to processor 904. In some embodiments, the computer system 900 may also include a cursor control 916, such as a mouse, a trackball, or cursor direction keys for communicating direction information and command selections to processor 904 and for controlling cursor movement on display 912. The cursor control 916 typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data and instructions that cause a machine to operation in a specific fashion. Such storage media may comprise non-volatile media and volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic, radio, or light waves, such as those generated during radio-wave and infra-red data communications, such as WI-Fl, 3G, 4G, BLUETOOTH, or wireless communications following any other wireless networking standard.

Various forms of media may be involved in carrying one or more sequences of one or more instructions to processor 904 for execution. For example, the instructions may initially be carried on a magnetic disk or solid state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, and stored in storage device 910, or other non-volatile storage for later execution.

What is claimed is:

1. A method to be performed by a mobile computing device comprising:
receiving a plurality of images from a camera;
generating a set of object detections for stationary objects appearing in the received images;
associating with each object detection a position of the camera at the time the image corresponding to the object detection was captured by the camera, the position being derived from a geographic position of the mobile computing device provided by a GPS receiver on the mobile computing device;
assigning the object detections to groups comprising object detections of the same object; and
for a detected object:
determining an object detection group corresponding to the detected object;
responsive to the object detection group having at least a threshold number of object detections:
determining a position of the detected object relative to the camera based on the determined object detection group; and
converting the detected object position to a geographic position based on the geographic position of the mobile computing device.

2. The method of claim 1, wherein the mobile computing device is physically located within a vehicle.

3. The method of claim 1, wherein the camera is an integrated component of the mobile computing device.

4. The method of claim 1, wherein the set of object detections is generated by inputting the received images into a neural network model loaded into a memory of the mobile computing device.

5. The method of claim 1, wherein the objects identified in the set of object detections are physically located in the environment about the vehicle and are captured within the image by the camera, wherein:
the objects comprise discrete shapes around which bounding boxes can be placed,
the objects are represented by a plurality of pixels located in the image, and
the objects are one of a plurality of object types.

6. The method of claim 5, wherein the object detections are grouped according to one or more characteristics of the object detections including at least one of: object type, bounding box size, and bounding box location.

7. The method of claim 5, wherein the position of a detected object relative to the camera is determined by solving a system of linear equations, each detection providing a plurality of equations in terms of the position of the camera and the pixel coordinates of the bounding box.

8. The method of claim 5, wherein each object detection includes the camera orientation at the time the image corresponding to the object detection was captured by the camera, and wherein the position of a detected object relative to the camera is determined by projecting a ray from a focal point of the camera through the center of the bounding box for each object detection.

9. The method of claim 8, wherein the position of a detected object relative to the camera is given by determining the position closest to the projected rays.

10. The method of claim 8, wherein a prior object size for a detected object type is known and the position of a detected object relative to the camera is given by computing a probability distribution along each ray and fusing each distribution, wherein:
at each position in a region along a ray the probability distribution indicates the probability of the object being at the position, where the region location and area are based on the prior object size.

11. The method of claim 1, further comprising:
positioning, based on the detected object geographic position, the detected object on a map displayed through a client map application on the mobile computing device.

12. The method of claim 11, further comprising:
responsive to positioning the object on a map displayed through a client map application, providing a notification alerting a user of the mobile computing device to information relevant to the position of the object on a screen of the mobile computing device through the client map application.

13. The method of claim 12, wherein providing of the notification comprises playing an audio alert on a speaker of the mobile computing device.

14. The method of claim 1, further comprising:
sending updates to an existing repository of map data located on a remote computing server physically distant from the mobile computing device, the updates comprising at least one of:
adding new detected object geographic positions to the map data; and
adjusting existing detected object geographic positions stored in the map data by comparing what detected object geographic positions are determined by the set of object detections.

15. A non-transitory computer-readable storage medium of a mobile computing device storing executable computer instructions, the instructions configured to, when executed by a hardware processor on the mobile computing device, perform steps comprising:
receiving a plurality of images from a camera;
generating a set of object detections for stationary objects appearing in the received images;
associating with each object detection a position of the camera at the time the image corresponding to the object detection was captured by the camera, the position being derived from a geographic position of the mobile computing device provided by a GPS receiver on the mobile computing device;
assigning the object detections to groups comprising object detections of the same object; and
for a detected object:
determining an object detection group corresponding to the detected object;
responsive to the object detection group having at least a threshold number of object detections:
determining a position of the detected object relative to the camera based on the determined object detection group; and
converting the detected object position to a geographic position based on the geographic position of the mobile computing device.

16. The computer readable storage medium of claim 15, wherein the mobile computing device is physically located within a vehicle.

17. The computer readable storage medium of claim 15, wherein the camera is an integrated component of the mobile computing device.

18. A mobile computing device computer system, the mobile computing device comprising a hardware processor and a GPS receiver, the hardware processor configured to perform steps comprising:
receiving a plurality of images from a camera;
generating a set of object detections for stationary objects appearing in the received images;
associating with each object detection a position of the camera at the time the image corresponding to the object detection was captured by the camera, the position being derived from a geographic position of the mobile computing device provided by the GPS receiver on the mobile computing device;
assigning the object detections to groups comprising object detections of the same object; and
for a detected object:
determining an object detection group corresponding to the detected object;
responsive to the object detection group having at least a threshold number of object detections:
determining a position of the detected object relative to the camera based on the determined object detection group; and
converting the detected object position to a geographic position based on the geographic position of the mobile computing device.

19. The mobile computing device of claim 18, wherein the mobile computing device is physically located within a vehicle.

20. The mobile computing device of claim 18, wherein the camera is an integrated component of the mobile computing device.
